(19) United States
(12) Patent Application Publication
(10) Pub. No.: US 2016/0328968 A1
(43) Pub. Date: Nov. 10, 2016

(54) Running red lights avoidance and virtual preemption system

(71) Applicant: Mohamed Roshdy Elsheemy, Akron, OH (US)

(72) Inventor: Mohamed Roshdy Elsheemy, Akron, OH (US)

(21) Appl. No.: 14/999,005

(22) Filed: Mar. 16, 2016

(51) Int. Cl. G08G 1/0967; G08G 1/0965; B60K 35/00; B60T 7/12; G08G 1/096; G01S 19/13

(52) U.S. Cl. CPC G08G 1/096725; G08G 1/096; G01S 19/13; B60K 35/00; B60T 7/12; G08G 1/0965; B60K 2350/2052; B60K 2350/2008; B60T 2201/03; B60T 2270/10

(57) ABSTRACT

The present invention integrates the in-car traffic light system of Elsheemy with the vehicle's automatic braking system to significantly reduce running red lights which causes outrageous accidents rates, injuries rates, death rates and damage rates at intersections, the present invention also provides a virtual preemption system integrated with the in-car traffic light system for both emergency vehicles and also civilians vehicles.

This application is related to: Internation Application Number (PCT/US14/56695) Filed by Mohamed Elsheemy on 20 Sep. 2014 and Comprehensive traffic control system US 2015/0243165 of Elsheemy. Also related to the U.S. Provisional Application No. 62/285,455 RUNNING RED LIGHTS AVOIDANCE AND VIRTUAL PREEMPTION SYSTEM filed by Mohamed Elsheemy on Oct. 30, 2015

### FIELD OF THE INVENTION

The present invention relates generally to traffic control systems and more particularly to US. Patent Application 2015/0243165 of Elsheemy and is referred herein as Elsheemy and the provisional application U.S. 62/285,455

The present invention integrates the In-Car Traffic Light System of Elsheemy with the vehicle's Automatic Braking System to significantly reduce running red lights which causes outrageous accidents rates, injuries rates, death rates and damage rates at intersections, the present invention also provides a Virtual Preemption System integrated with the In-Car Traffic Light System for both emergency vehicles and also for civilian vehicles.

### BACKGROUND AND SUMMARY OF THE INVENTION

The vehicle unit and the emergency vehicle unit:

As been described in Elsheemy.

The ordinary vehicle unit and the emergency vehicle unit uses a long range radio frequency transceiver module, preferably (one to two mile) range, and a short range radio frequency transceiver module, preferably (0.1 mile range), along with a cellular-network circuit board, antenna, a thermal module and a GPS receiver module. The circuit board is considered the brain component of the unit, it runs the entire system of the unit, the circuit board consist of a few computer chips. There are both digital-to-analog and analog-to-digital conversion computer chips within the circuit board. They convert audio signals going out from analog to digital, and then they convert the audio signals from digital back into analog, this unit also comprises a bluetooth module to communicate with the LCD unit or the LED strip unit.

The flash memory and ROM components of the unit circuit board serve as a storage location for the unit. They store the vehicle identification number “VIN” code, cellphone codes (SIM card codes), the GPS database, the GPS readings; “coordinates, speed, heading and date/time”, the RFID active tag readings “tag number (chip ID) and date/time”, and the in-car traffic light cycle application which is a component of the in-car traffic light system, as well as the entire operating system.

The microprocessor is in charge of dealing with all the tasks that are to be performed by the unit. It also focuses on the unit's control signals (to and from the base station) and command options. It helps to interconnect all of the terminal LCD main functions.

The liquid crystal display (LCD), is a terminal display and connected to the vehicle unit through a Universal Serial Bus (USB) cable and comprises a number of LED indicators, microphone, speaker, a camera and a number of buttons. This unit may also comprises a bluetooth module in some embodiments.

In some embodiments the LCD unit may comprises an intersection icon similar to the LED indicators to indicate the location of an intersection programmed with fixed traffic cycles of Elsheemy.

In other embodiments the vehicle may include the LCD unit and/or a separate LED strip comprises the LED indicators and the intersection icon indicator, the LED strip could be in horizontal position or vertical position, the LED strip unit may comprises a bluetooth module.

Also in other embodiments the vehicle may include a head-up display, (also known as a HUD—is any transparent display that presents data without requiring users to look away from their usual viewpoints. The origin of the name stems from a pilot being able to view information with the head positioned “up” and looking forward, instead of angled down looking at lower instruments. A HUD also has the advantage that the pilot's eyes do not need to refocus to view the outside after looking at the optically nearer instruments). In this case the vehicle windshield will be the transparent display to display the in-car traffic lights and other icon indicators.

Also in other embodiments the vehicle unit may contain the LCD or the LED strip in the same housing.

The LCD or the LED strip along with the vehicle unit will be referred herein as V10 unit as in Elsheemy.

The emergency vehicle unit (including the police vehicle unit) comprises electronic components similar to the vehicle unit and can communicate with the vehicle unit via the long range or the short range radio frequency.

Integrating the In-Car Traffic Light System of Elsheemy and the Automatic Braking System, also integrating the In-Car Traffic Light System of Elsheemy and the Virtual Preemption System for both emergency vehicles and civilians vehicles.

The rapid growth in the developing countries has caused a problem with the demand of electricity. Rolling blackouts have been occurring on a regular basis, oil and gas companies cannot supply enough gas to meet the demand, and system failures have also plagued these countries. While going without power for a few hours once in a while is tolerable, it becomes very aggravating when it happens day after day, month after month. Also hurricanes and severe storms can knockout power-lines and cause blackout. Traffic light relies on electricity to illuminate its lamps or its displays to control the traffic in busy roads. Generally when a traffic light is non-operational, all drivers are required to stop at the intersection, take turns as if it were a four-way stop and proceed through with caution, but that does not always happen and car accidents are sadly a frequent result. Additionally, heavy fogs, snow storms and sandstorms may cause the drivers to lose the line-of-sight with the traffic light. Also intersection crashes cost U.S alone a number of $ billions annually, account for more than one-fifth of all highway crash fatalities nationally according the Federal Highway Administration.

### The National Traffic Signal Report Card: Technical Report

Developed by the National Transportation Operations Coalition (NTOC) used three key components to estimate the costs of traffic signal operations:

1.) Appropriate traffic signal hardware
2.) Routine traffic signal timing updates; and
3.) Maintenance performed by well-trained technicians

Traffic signal hardware consists of several primary components: the signal heads, sensors to detect vehicular traffic, and the signal controller. Having up-to-date equipment is important to sound traffic signal operations. The signal controller should be upgraded, at a cost of approximately $10,000 each, minimally every 10 years.

Routine traffic signal timing updates cost $3,000 or less per intersection. Signal timing plans should be updated every three to five years, or more frequently depending on growth and changes in traffic patterns.

Well-trained technicians are needed to maintain traffic signal hardware so that the signal system is operating in good order and according to the timing updates. A current assumption is one traffic signal technician can maintain 30-40 signals. The average costs of a technician is $56,000 per year which includes salary, benefits (approximately 30-35% of salary), vehicles, parts/supplies, and other required items.

Given the cost data above and assuming the U.S. has 265,000 signals, the annual costs associated with signal timing can be calculated.

### Hardware:

Each year 1/10 of the controllers are replaced

265,000/10=26,500 controllers per year

Total cost is $256 million per year

### Timing Updates:

Signal retiming interval is every four years

265,000/4=66,250

$3,000 per signal

Total cost is roughly $200 million per year

### Maintenance:

One technician maintains 30 signals

265,000/30=8,822 technicians

$56,000 per technician

Total cost is roughly $500 million per year

Grand total cost for signal timing per year across the U.S. is $965 million.

According to the Arizona Department of Transportation, a modern traffic signal can cost $80,000 to $100,000 to install, depending on the complexity of the location and the characteristics of the traffic in the area. According to the City of Woodbury, Minn. website, a complete traffic signal for a standard four-way intersection will cost around $250,000 to $300,000. Other expenses like project inspection and design can bring up the cost to almost $300,000.

### Implementation Costs for Automated Red Light Camera

A red light camera (short for red light running camera) is a type of traffic enforcement camera that captures an image of a vehicle which has entered an intersection in spite of the traffic signal indicating red (during the red phase). By automatically photographing vehicles that run red lights, the photo is evidence that assists authorities in their enforcement of traffic laws. Generally the camera is triggered when a vehicle enters the intersection (passes the stop-bar) after the traffic signal has turned red. Typically, a law enforcement official will review the photographic evidence and determine whether a violation occurred. A citation is then usually mailed to the owner of the vehicle found to be in violation of the law.

[symbol]

Automated red light camera systems range from $67,000 to $80,000 per intersection.

Automated red light camera systems consist of fixed costs (the costs of the equipment and installation) and variable costs (the cost associated with the back office ticket processes). Overall, the cost for implementing an automated red light enforcement system depends on the geometry of the intersection, and the number lanes/approaches monitored. System costs include the cost of the camera (approximately $50,000), in-pavement inductive loop detectors ($5K per leg), and costs associated with camera housings, poles, flash slaves, and wiring ($5,000 to $8,000). The City of San Francisco, Calif. spent $80,000 per intersection which included installation of loops, wires, poles, and cameras, and the City of Jackson, Mich. spent $67,000 (1998 prices) per intersection for a system that included one wet film camera, housing, loop, pole, and installation. The variable costs are unique to each jurisdiction's ticketing process and procedures, as well as agreement between the jurisdiction and contractor processing the violations.

Traffic signal preemption (also called traffic signal prioritization) is a type of system that allows the normal operation of traffic light to be preempted. The most common use of these systems is to manipulate traffic signals in the path of an emergency vehicle, halting conflicting traffic and allowing the emergency vehicle right-of-way, to help reduce response times and enhance traffic safety. Signal preemption can also be used by light-rail and bus rapid transit systems to allow public transportation priority access through intersections, or by railroad systems at crossings to prevent collisions.

Traffic preemption devices are implemented in a variety of ways. They can be installed on road vehicles, integrated with train transportation network management systems, or operated by remote control from a fixed location, such as a fire station, or by a 9-1-1 dispatcher at an emergency call center. Traffic lights must be equipped to receive an activation signal to be controlled by any system intended for use in that area. A traffic signal not equipped to receive a traffic preemption signal will not recognize an activation, and will continue to operate in its normal cycle.

Vehicular devices can be switched on or off as needed, but in the case of emergency vehicles they are frequently integrated with the vehicle's emergency warning lights. When activated, the traffic premption device will cause properly equipped traffic lights in the path of the vehicle to cycle immediately, to grant right-of-way in the desired direction, after allowing for normal programmed time delays for signal changes and pedestrian crosswalks to clear.

Traffic signal preemption systems integrated with train transportation networks typically extend their control of traffic from the typical crossarms and warning lights to one or more nearby traffic intersections, to prevent excessive road traffic from approaching the crossing, while also obtaining the right-of-way for road traffic that may be in the way to quickly clear the crossing.

Fixed-location systems can vary widely, but a typical implementation is for a single traffic signal in front of or near a fire station to stop traffic and allow emergency vehicles to exit the station unimpeded. Alternatively, an entire corridor of traffic signals along a street may be operated from a fixed location, such as to allow fire apparatus to quickly respond through a crowded downtown area, or to allow an ambulance faster access when transporting a critical patient to a hospital in an area with dense traffic.

Traffic signal preemption systems sometimes include a method for communicating to the operator of the vehicle that requested the preemption (as well as other drivers) that a traffic signal is under control of a preemption device, by means of a notifier. This device is almost always an additional light located near the traffic signals. It may be a single light bulb visible to all, which flashes or stays on, or there may be a light aimed towards each direction from which traffic approaches the intersection. In the case of multiple notifier lights at a controllable intersection, they will either flash or stay on depending on the local configuration, to communicate to all drivers from which direction a preempting signal is being received. This informs regular drivers which direction may need to be cleared, and informs activating vehicle drivers if they have control of the light (especially important when more than one activating vehicle approaches the same intersection). A typical installation would provide a flashing notifier to indicate that an activating vehicle is approaching from ahead or behind, while a solid notifier would indicate the emergency vehicle is approaching laterally. There are variations of notification methods in use, which may include one or more colored lights in varying configurations.

Emergency preemption equipment was deployed at several intersections in British Columbia, Canada at a cost of $4,000 (Canadian) per intersection according to U.S. Department of Transportation Intelligent Transportation Systems Joint Program Office.

The foregoing discussion has shed some light on the extremely costly conventional intersection system to provide safety for street traffic at intersections. Whereas the present invention along with Elsheemy can provide a highly efficient system for extremely low cost.

The need for a highly efficient and extremely low cost system that overcome the foregoing problems is a noble goal. A system that do not rely on expensive infrastructure, a system that can replace the conventional existing traffic light systems without compromising the safety of the drivers or pedestrians. a system that can fit all geographic rural and urban areas in rich and poor countries. a system that can fit any road or intersection shape. a system that do not depend on vehicle to vehicle communications or road/vehicle detection sensors that may cause accidents or jams wherein a very good chance of wrongly interpreting the sensors signals. a system that can be extremely efficient in areas covered with or without cellular network service, a system that can be integrated with the automatic braking system of the vehicle to avoid running red lights, thus to reduce; accidents rates, death rates, injuries rates and damage rates at intersections. A system that can provide a highly, efficient and extremely low cost preemption priority routes for emergency vehicles and also for civilians vehicles in some cases. Additionally, the in-car traffic light system of Elsheemy integrated with the automatic braking system and the present virtual preemption system can make a unique system suitable for the future self-driving vehicles.

### BRIEF DESCRIPTION OF THE DRAWINGS

FIG. 1 Illustrates the location and the position of the vehicle LCD 40 unit inside the car as one embodiment of the present invention and also as of Elsheemy.

FIG. 2 Illustrates an example of the vehicle LCD unit 40 (front and top view).

FIG. 3 Illustrates an example of the vehicle LCD unit 40 (showing the traffic light shapes displayed on a colored screen).

FIG. 4 Illustrates an example of a horizontal LED strip.

FIG. 5 Illustrates an example of a vertical LED strip.

FIG. 6 Illustrates an example of a fixed traffic light cycle.

FIG. 7 Illustrates an example of numbering the intersections on a horizontal street section coded C joins a vertical street section coded D joins a horizontal street section coded K.

FIG. 8 Illustrates an example of numbering the intersections on a horizontal street coded A

FIG. 9 Illustrates an example of numbering the intersections on a vertical street coded B

FIG. 10 Illustrates an example of numbering the intersections on a horizontal street coded F intersects with a vertical street coded E.

FIG. 11 Illustrates an example of numbering the intersections on a horizontal street coded G intersects with a vertical street coded H.

FIG. 12 Illustrates an example of SQL table Section_Location to locate a specific geographical section.

FIG. 13 Illustrates an example of SQL table to link between position coordinates on a leg-segment between two consecutive intersections on the same street and intersection ID.

FIG. 14 Illustrates an example of SQL table to link between intersection ID and traffic light cycle ID and the intersection coordinates.

FIG. 15 Illustrates an example of SQL table to link the traffic light phases and the respective cycle ID.

FIG. 16 Illustrates an example of a horizontal LED strip located inside a vehicle.

FIG. 17 Illustrates an example of a vertical LED strip located inside a vehicle.

FIG. 18 Illustrates an example of the virtual preemption system of the present invention.

### DETAILED DESCRIPTION OF THE INVENTION

The present invention covers a lot of systems that may cause it to take advantage of the well known (radio, GPS, cellular network, RFID tags, database, computer science, vehicle identification number, automatic brake, Tilt sensors, common knowledge, . . . etc) technologies that are not solely limited to a specific invention or system. Also the present invention takes advantage of the well known electronic circuit elements such as LCD, memory chips, GPS chips, LEDs, microprocessors, transceivers bluetooth, heads-up display, . . . etc. which also not solely limited to a specific invention or system. Therefore, the components of the present invention hoped to be taken as one entity in order not to exit the spirit and the concept of the present invention.

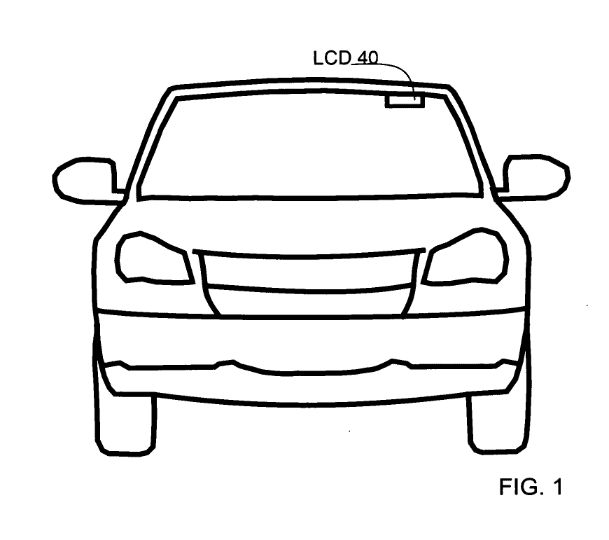

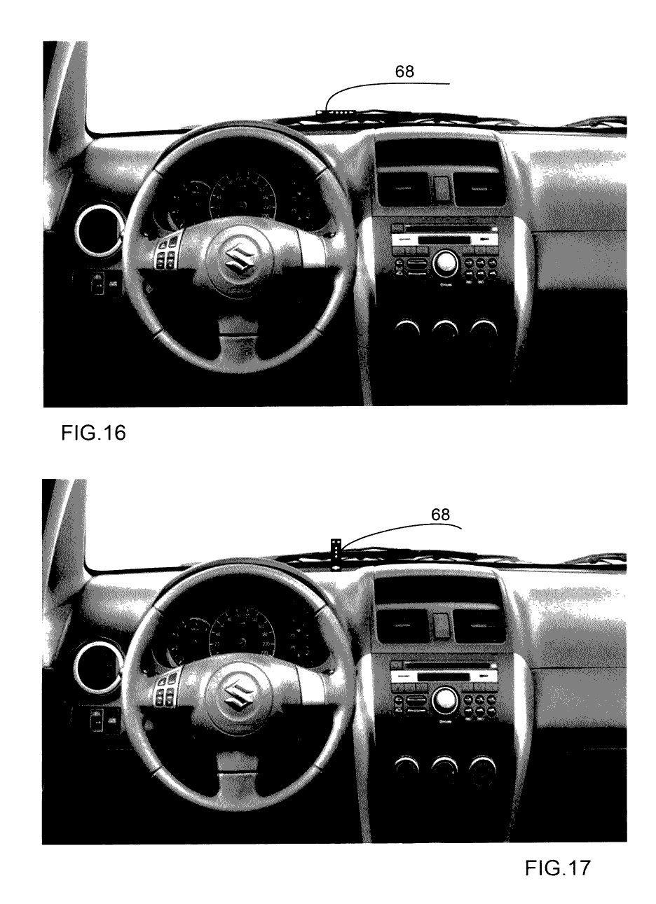

As shown in FIG. 1, FIG. 16 and FIG. 17, the vehicle LCD unit 40 of Elsheemy and the LED strip 68 can be installed at any suitable location inside the vehicle to provide a comfortable line of sight with the driver, FIG. 1 is an example of the LCD 40 installed facing the driver without blocking his line of sight with the road. As in FIG. 16 and FIG. 17 the LED strip 68 installed on top of the dash board.

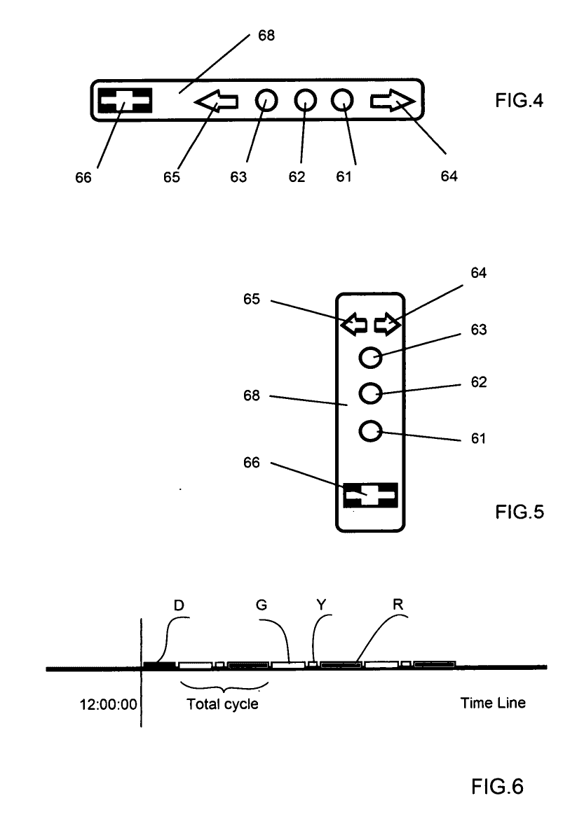

As shown in FIG. 2, FIG. 4 and FIG. 5 the vehicle LCD unit 40 of Elsheemy and the LED strip 68 comprises a green LED indicator 61, a yellow LED indicator 62, a red LED indicator 63, a green right arrow LED indicator 64, and a green left arrow LED indicator 65, the LED indicators are used to illuminate the synchronized LED's in-car traffic light phases. The intersection icon 66 is used to indicate a location of an intersection programmed with the fixed traffic light cycles of Elsheemy during yellow or red light phase.

The in-car traffic light system as best described in Elsheemy is in-vehicle virtual traffic light system that mimics the conventional street intersection traffic lights. The system relies on a database of GPS track points along the roads, and a database of traffic light cycles that fit all possible variation of traffic from the busiest traffic to the lowest traffic at street intersections during the different hours of the day. The in-car traffic light system neither depend on vehicle to vehicle communication nor intersection to vehicle communication nor the traffic network communication, with extremely high efficiency that mimics the actual street traffic lights performance. Also, the present in-car traffic light system can work on smartphones and consumer-grade GPS receiver units.

A typical two-road intersection generally has four legs, each intersection leg is represented by a leg segment. Traffic lights are used to control safety and regulate traffic at intersections, by alternating the right of way accorded to the moving vehicles.

Laying street centerline GPS track points to create street intersections GPS leg-segments. The GPS database of programmed track points creates a virtual trail for each leg-segment. The track points could be dropped as close together along the leg-segment or as close together in the vicinity of the street intersection and as far apart away from the intersection.

The consumer-grade GPS receivers, GPS-enabled smartphones and the vehicle unit V10 of Elsheemy can be loaded with the database of track points, the traffic light cycles and maps enough to cover an entire country, state or quite few cities of interest. Also the owners of the vehicles, GPS receivers or the GPS-enabled smartphones may obtain the GPS database, the traffic light cycles and maps in CD-ROM format and load them onto the receiver or the smartphone or they may use microSD memory cards that are preloaded with database of track points and the traffic light cycles that can easily be added to the GPS receivers or the GPS-enabled phones. Finally, the GPS-enabled smartphones may also download the GPS data, the traffic light cycles and maps from the internet by using the in-car traffic light system app.

The green light allows traffic to proceed, the yellow light indicating prepare to stop short of the intersection, and the red light prohibits any traffic from proceeding.

Flashing red: treated as a stop sign, also can signal the road is closed. Flashing yellow: caution, crossing or road hazard ahead. Flashing green: varies among jurisdiction; can give permission to go straight as well as make a left turn in front of opposing traffic (which is held by a steady red light), can indicate the end of a green cycle before the light changes to a solid yellow, or (as in some countries indicates the intersection is a pedestrian crosswalk).

Traffic signal timing is used to determine which approach has the right-of-way at an intersection, and how much green time the traffic light shall provide at an intersection approach, how long the yellow interval, how long the red light and how long green turning light, should be, and how long the pedestrian “walk” signal should be.

The GPS receiver 28 in the vehicle unit V10 of Elsheemy enables the unit to determine the coordinates, speed, heading and date/time at real-time status, by matching and comparing the GPS coordinates to the data from the GPS database, the unit V10 can determine the exact leg segment. The segment could be a section of a road between two consecutive road-intersections, or it could be an intersection leg of a length lies between (0.1 mile and 0.5 mile) depending on the speed limit of the road. Generally, each leg segment is identified by its road-name and a serial number or identified by a code. Occasionally, some cities may have similar road names, therefore the GPS database uses special codes similar to the zip codes to identify different cities or geographic sections. The road names could be coded to eliminate any chance of having a repeated name for different roads inside the same geographic section.

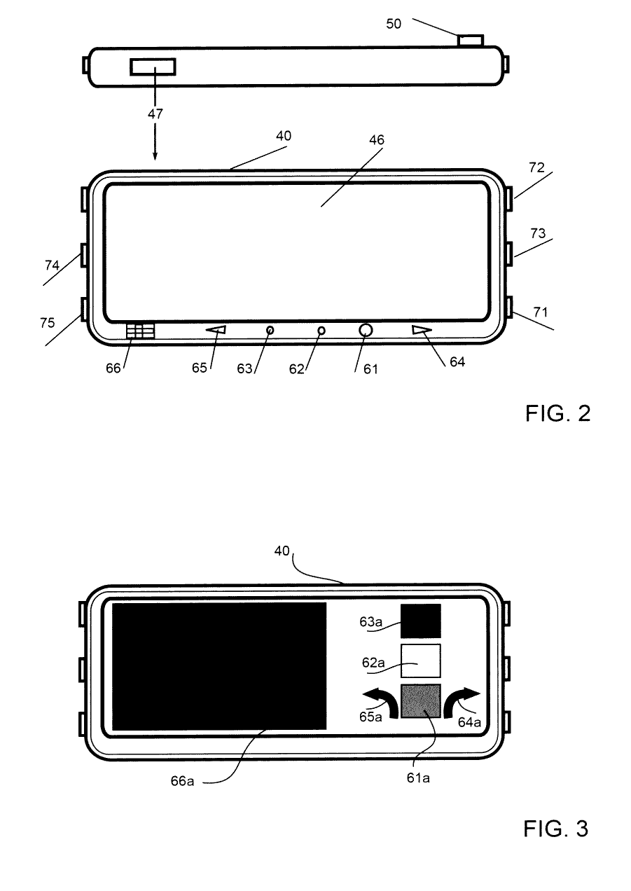

The vehicle unit's GPS receiver 28 of Elsheemy, determines the coordinates, speed, heading and date/time at real-time status, and by using the GPS database, the vehicle unit can determine the corresponding leg segment, the leg segment along with the direction will trigger the programmed traffic cycle. And the vehicle's LCD will illuminate the corresponding LED indicator 61 or 62 or 63 or 64 or 65. Or in another embodiment as shown in FIG. 3, the right turn arrow 64a, the left turn arrow 65a, the green light 61a, the yellow light 62a and the red light 63a will be illuminating on the screen of the colored LCD or the heads-up display. The red or yellow light shape 66a will only appear on the screen when the vehicle is less than 20 meters away from a programmed intersection with in-car fixed light cycles to indicate the location of this intersection during a yellow or red light phase.

SQL (Structured Query Language) is a computer language aimed to store, manipulate, and query data stored in relational databases. In a relational database, data is stored in tables. A table is made up of rows and columns. Each row represents one piece of data, and each column can be thought of as representing a component of that piece of data. For example, if we have a table for recording GPS tracking points information, then the columns may include information such as Latitude, Longitude, and Street name or INT ID as shown in FIG. 13. As a result, when we specify a table, we include the column headers and the type of data for each column. We may also decide to place certain limitations, or constraints, to guarantee that the data stored in the table makes sense.

The GPS latitude and longitude coordinates will be in decimal degrees for database and programming use. A typical consumer-grade GPS units (e.g. Garmin GPS Map 76C) which deliver 1-3 m accuracy. For that grade of GPS, reporting 5 decimal places will preserve a precision of 1.1 m accuracy. An example:

### Lat N 41° 5′ 3.588″=41.08432976612652°

### Lon W 81° 30′ 51.4938″=−81.51430423111378°

For reporting 5 decimal places the Lat will be 41.08432 and the Lon will be −81.51430 For the programming purposes and database design, the Lat and the Lon values will be used as:

### Lat 41.08432, LatA=410, LatB=8432 and LatC=41084

### Lon −81.51430, LonA=815, LonB=1430 and LonC=81514

Realize that the 1st three numbers=LatA or LonA, the 1st five numbers=LatC or LonC and finally the last four numbers=LatB or LonB.

The GPS receiver module 28 of the V10 and the consumer-grade GPS units or the smartphones may automatically record a position each second.

Two consecutive recording positions can determine the direction of moving. Record the first position and obtain its LatB and LonB, then record the next position while moving NE (northeast)) for instance and obtain its LatB and LonB. For example: 1st position Lat 41.07811, Lon −81.51442 and next position Lat 41.07816, Lon −81.51433

1st position: LonB=1442, 2nd position: LonB=1433

Realize that LonB decreases eastbound.

1st position: LatB=7811, 2nd position: LatB=7816

Realize that LatB increases northbound.

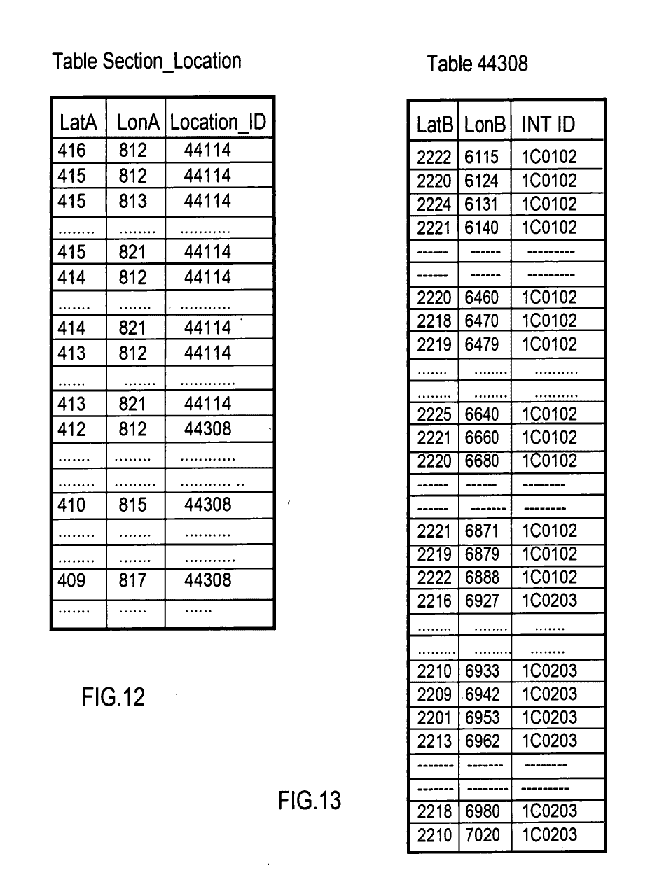

FIG. 12 shows SQL table. In that table a city or a region is divided into a number of geographic sections each section is about 8 by 8 miles, and identified by its LatA and LonA.

The table Section_Location comprises three columns, the 1st column for LatA, 2nd column for LonA and the last column for location ID. For example, the position Lat 41.07629, Lon −81.52229 has LatA=410, LatB=7629 and LonA=815, LonB=2229, by applying the SELECT SQL command for Location ID, WHERE LatA=410 AND LonA=815, the result will be 44308.

44308 is the actual zip code for downtown the city of Akron, Ohio where the Lat 41.07629, Lon −81.52229 of this position belongs.

The same way with position Lat 41.45533, Lon −81.73770 has LatA=414, LatB=5533 and LonA=817, LonB=3770, and by applying the SELECT SQL command for Location ID, WHERE LatA=414 AND LonA=817, the result will be (44114). 44114 is the actual zip code for downtown the city of Cleveland, Ohio where the Lat 41.45533, Lon −81.73770 of this position belongs.

### Distance Between the Vehicle and an Intersection in Meters

LatB of the vehicle−LatB of the intersection=Y
LonB of the vehicle−LonB of the intersection=X

Distance=1.112\sqrt{X*X+Y*Y}

### Coding the Streets and Marking the Intersections Inside a Geographic Area:

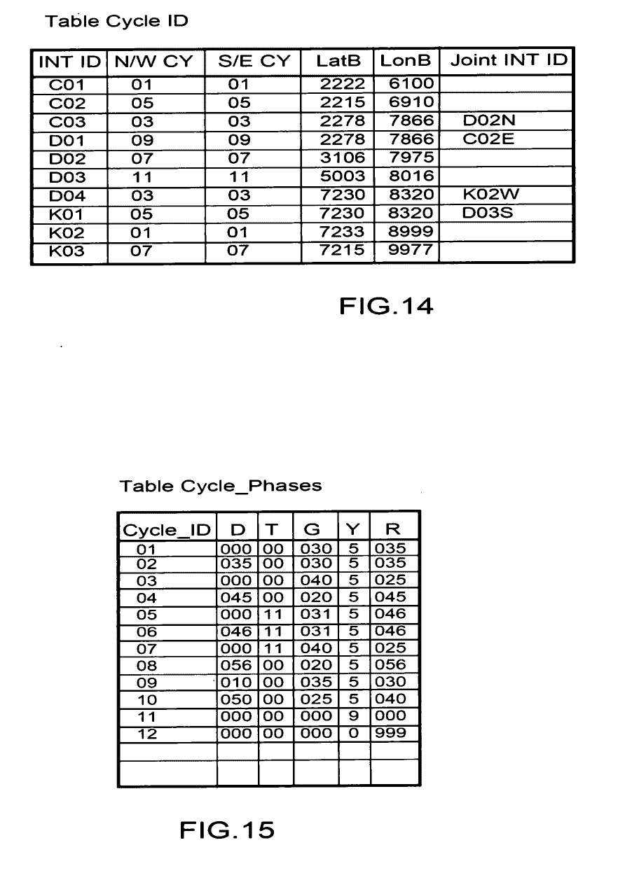

For the SQL database (SQL as an example of a suitable database), there will be a first table to locate the geographic area based on the Latitude/Longitude of the moving vehicle as shown in FIG. 12. A second table to locate the street name(code) and the intersections ID where the vehicle moving between them based on the Latitude/Longitude of the moving vehicle as shown in FIG. 13. And a third table to locate the In-car traffic light cycles ID for the upcoming intersections based on the intersection ID and the direction of movement. Also the third table to locate the Latitude/Longitude of the upcoming intersections based on the intersection ID and the direction of movement as shown in FIG. 14. A fourth table to provide the delay time, the left-turn time phase, the green time phase, the yellow time phase and the red time phase based on the In-car traffic cycle ID as shown in FIG. 15.

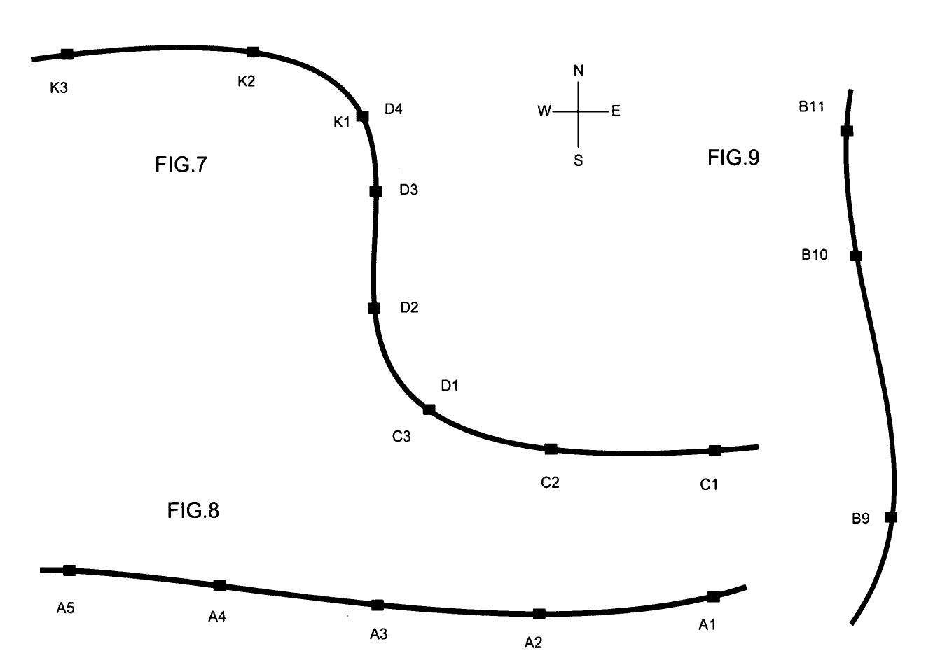

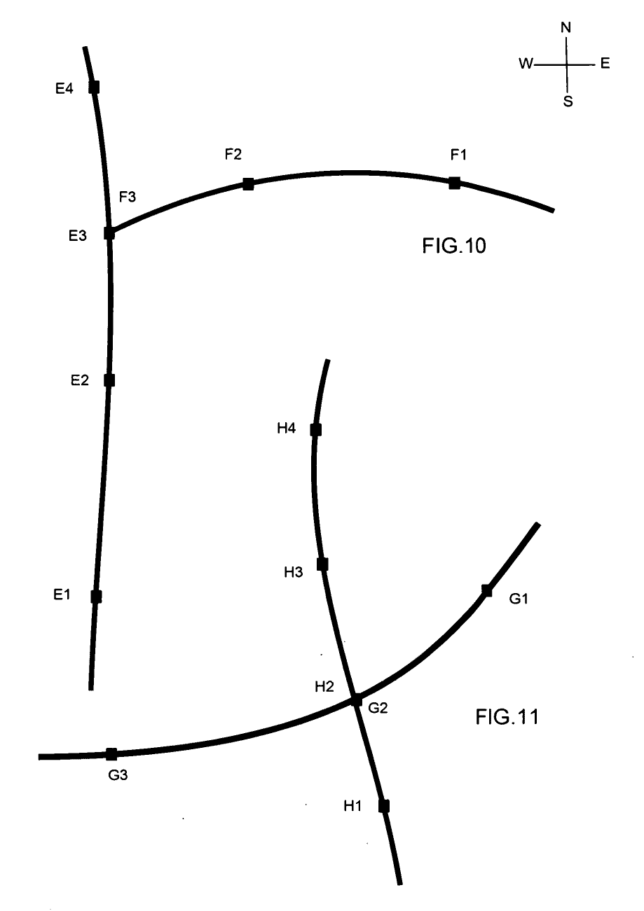

Naming or Coding Streets Located Inside a Certain Geographic Area Must Follow these Rules:
The street can take a single or more alphabet letter to define a street or a section of a street as shown in FIGS. 7,8,9,10 and 11.
Two streets or sections must not have the same name (code) inside the same geographic area.
A street or a section of street has to be defined as horizontal or vertical or one way, 1 for horizontal, 2 for vertical, 3 for oneway horizontal, 4 for oneway vertical.
A geographic area can be an area has borders as Latitude 1, Latitude 2, Longitude 3 and Longitude 4 as shown in FIG. 12.
   Numbering the Intersections on a Certain Street Must Follow these Rules:
For horizontal streets, start numbering ascending Westbound as shown in FIG. 8, for vertical streets, start numbering ascending Northbound as shown in FIG. 9.
When two streets intersect, the intersection must have a different number for each street as shown in FIG. 10 and FIG. 11. Intersection F3 belongs to street F and intersection E3 belongs to street E, intersection F3 and E3 has the same latitude/longitude.
When two streets join to form one street, the joint intersection must have a different number for each street as shown in FIG. 7. Intersection C3 belongs to street C and intersection D1 belongs to street D. Intersection C3 and D1 has the same latitude/longitude.
The intersection is defined by its street code and its number as shown in FIG. 8 street code is A and intersections A1,A2,A3,A4 and A5. For FIG. 9, street code is B and the intersections are B9, B10 and B11.
Moving between two consecutive intersections on the same street can determine the In-car traffic light cycles at the upcoming intersections consecutively, also can determine the coordinates of these intersections. The joined streets are considered a same street.
When making a right or left turn at an intersection of two or more streets, moving between two consecutive intersections on the new street can determine the In-car traffic light cycles at the upcoming intersections consecutively on the new street, also can determine the coordinates of these intersections.

FIG. 13 illustrates an SQL Table 44308 which comprises 3 columns, the 1st column for LatB, 2nd column for LonB and the last column for INT ID (intersection ID), by applying the SELECT command for INT ID, WHERE LatB=2224 AND LonB=6131, the result will be 1C0102. What does this code mean?

1=horizontal street, C=the street code or name, 01 and 02 are two consecutive intersections on street C.

The vehicle moving westbound on street C between C01 and C02 intersections, therefore the calculations will generate next intersections automatically since intersection numbering ascending westbound on horizontal streets.

Thus, the intersections will be C02, C03 and from C03 the database will determine D02,D03,D04 and from D04 the database determines K02,K03

FIG. 14 illustrates an SQL Table Cycle ID which comprises 6 columns, the 1st column for INT ID, the 2nd column for N/W CY (northbound or westbound cycle ID), 3rd column for S/E CY (southbound or eastbound cycle ID), 4th column for LatB (LatB for an intersection), 5th column for LonB (LonB for an intersection), 6th column for Joint INT ID (intersection ID for joint intersection).

By applying the SELECT command for N/W CY, S/E CY, LatB, LonB, Joint INT ID WHERE INT ID=C02 and INT ID=C03

As a result the database determines the cycle ID and the coordinates for the upcoming intersections.

N/W CY=Northbound or Westbound light cycle ID
S/E CY=Southbound or Eastbound light cycle ID
Joint INT ID=the intersection ID where two streets join

E, W, N and S are the direction of moving.

FIG. 15 illustrates an SQL table Cycle_Phases which comprises 6 columns, the 1st column for the cycle ID and the 2nd column for D (delay time in seconds), 3rd column for T (left turning time 6 green+5 yellow in seconds), 4th column for G (green time in seconds), 5th column for Y (yellow time 5 seconds), 6th column for R (red time in seconds).

An example of cycle ID 05, the timing phases will be 000 11 031 5 046

Let's break up this code to understand what does it mean. The 1st three digits (000) for delay time in seconds, the next two digits (11) is the time for the left turn signal phase 6 seconds solid green arrow and 5 seconds yellow arrow phase will be in blinking green arrow form, the next three digits (031) is the time for the green light phase, the next digit (5) is the time for the yellow light phase, and finally the last three digits (046) is the time for the red light phase. Realize that the total time of the cycle is 93 seconds.

FIG. 6 Illustrates the time line of a fixed traffic light cycle wherein the first cycle started after D time in seconds from a reference time (12:00:00 midnight in this example), after that the cycle repeats itself. D time is the delay time before the start of the first repetition.

The cycles example in the SQL table Cycle_Phases were based on a simple formula as following:

Cycle 01 and cycle 02 are for two road intersection that have the same traffic volume in each road.

For road 1: D1,T1,G1,Y1 and R1, we assumed T1=11 seconds, 6 green+5 yellow left turn arrow signal, and Y1=5 seconds.

For road 2: D2,T2,G2,Y2 and R2, we assumed T2=11 seconds, 6 green+5 yellow left turn arrow signal, and Y2=5 seconds.

Cycle 2 timing must rely on cycle 1 timing (cycle 1 and Cycle 2 are a pair cycles), and calculated based on these simple formulas;

R1=T+Y+G2

R2=T+Y+G1

D2=D1+R2

Cycle total time=T+Y+G+R

Cycle 03 and cycle 04 are for two road intersection that have a busy traffic in one road and slow traffic in the other.

Cycle 05 and cycle 06 are for two road intersection that have the same traffic in each road and also have left turn light signals.

Cycle 07 and cycle 08 are for two road intersection that have busy traffic in one road and slow traffic in the other and the busy road have left turn signals.

Cycle 09 and cycle 10 are for two road intersection that have busy traffic in one road and slow traffic in the other and the 1st cycle in the busy road started after 10 seconds from Mid night (as a reference).

Cycle 11 for always yellow signal. Cycle 12 for always red signal or a stop sign.

In the database example the 1st 3 track points from the intersection are dropped 10 meter apart, then after that the next track points are 25 meter apart, also 100 meter apart in high speed roads. For the one way streets the track points will be dropped on the far left side of the street in direction of traffic. The main purpose for having big distance between track points is to have track points just enough to provide a very accurate database (or just drop the track points very close to each other along the leg segment). In this case the SELECT SQL command will be used with WHERE and BETWEEN commands to locate coordinates between a 1st position and a 2nd position. The 2nd position can be generated as following:

We can add or subtract a value to a 1st position LatB, LonB

For directions E and NW (add to Lat, add to Lon), for directions W and SE (subtract from Lat, subtract from Lon), for directions S and SW (add to Lat, subtract from Lon). Finally for directions N and NE (subtract from Lat, add to Lon). [E, NW (+,+) . . . W, SE (−, −) . . . S, SW (+, −) . . . N, NE (−, +)]

For LatB and LonB, the added values will be 12 to initiate the 1st search then if there is no result, the next added value will be 30, and if no result come the next added value will be 120. For LatC and LonC the added value will be 4 for example.

The database tables shown in FIG. 13 are designed to initiate the intersection search to determine the intersection ID of two intersections the vehicle moving between them based on the vehicle latitude/longitude, after that the database can generate the upcoming intersections ID based on the direction of moving. Therefore, the vehicle will know the status of the traffic light phases at each upcoming intersection ahead of time even before the vehicle reach these intersections, and in case of a green light phase for proceeding followed by a red light phase in the next approaching intersection the green LED indicator 61 may start blinking to warn the driver of the upcoming stop at the next intersection especially if the intersections are located in close proximity. Also by knowing the latitude/longitude of the upcoming intersections ahead of time, the vehicle can calculate the Safe Distance and the Stopping Distance ahead of time to be prepared for Running Red Lights avoidance.

Furthermore, the database tables shown in FIG. 13 are designed to initiate the intersection search to determine the intersection ID of two intersections the vehicle moving between them based on the vehicle latitude/longitude, after that the database can generate the upcoming intersections ID based on the direction of movement. Therefore, even there is a weak or no GPS signal for short time caused by tall buildings blocking the GPS satellite signals, the functionality of the system will not be affected.

When the distance between the vehicle and an upcoming intersection programmed with fixed light cycles is less than 20 meters for example during the yellow or the red light phase of a fixed light cycle at this intersection, in one embodiment of the LCD display 40 or the LED strip 68 or the heads-up display, an intersection icon 66 similar to the LED indicators will indicate the location of this intersection as shown in FIG. 4 and FIG. 5.

In another embodiment, the intensity of the yellow LED indicator 62 or the red LED indicator 63 could be increased to indicate the location of this intersection when the vehicle is less than 20 meters away.

In another embodiment an audio alert could be used to indicate the location of this intersection when the vehicle is less than 20 meters away during the yellow or the red light phase.

### Sun Visor and Sunglasses

A sun visor is a component of an automobile located on the interior just above the windshield (also known as the windscreen). They are designed with a hinged flap that is adjustable to help shade the eyes of drivers and passengers from the glare of sunlight.

Sunglasses offer protection against excessive exposure to light, including its visible and invisible components.

The most widespread protection is against ultraviolet radiation, which can cause short-term and long-term ocular problems such as photokeratitis, snow blindness, cataracts, pterygium and various forms of eye cancer. Medical experts advise the public on the importance of wearing sunglasses to protect the eyes from UV; for adequate protection, experts recommend sunglasses that reflect or filter out 99-100% of UVA and UVB light, with wavelengths up to 400 nm.

In one embodiment of this invention the sun visor will be made of transparent materials similar to Sunglasses to allow the driver to have line-of-sight with the LCD 40 or the heads-up-display.

### Dangers of Running Red Lights

Unfortunately, speeding and distracting while driving, as well as inability to see the traffic control device in time to comply are common problems. also not every vehicle driver conscious to follow the law. Sometimes, people are too impatient or too rushed to stop for the red light. They charge through the intersection, risking a wreck in their impatience to get where they are going without stopping. It's very obvious and common sense that running a red light would be dangerous and can cause an accident. After all, if you have a red light, the other traffic has a green light and is expecting to be able to continue through the intersection without any problems. Ignoring traffic signals is one of the major causes of accidents. Red-light running is estimated to cause more than 170,000 injuries and approximately 900 deaths per year in the US (SOURCE: Federal Highway Administration Red-Light Running Web Site (2008), According to some major cities, car crashes that occurred as a result of running red lights cost an average of $200 million per city each year.

Even though clearance intervals—both lengthening yellow-change intervals as well as providing an all-red clearance interval—together with increasing the size of signal lenses, have been shown to improve intersection safety. Increasing the length of the yellow-change interval in accordance with the recommended Institute for Transportation Engineers (ITE) formula has been shown to slightly decrease the chance of red-signal violations. Providing red clearance intervals and increasing the yellow-change interval have been shown to slightly decrease late exits from intersections since distracting while driving still responsible for the majority of Running Red Lights.

### Automatic Braking:

Automatic braking is a technology for vehicles to sense an imminent collision with another vehicle, person or obstacle; or a danger such as a high brakes or by applying the brakes to slow the vehicle without any driver input. Sensors to detect other vehicles or obstacles can include radar, video, infrared, ultrasonic or other technologies.

The present invention integrating the In-car traffic light system of Elsheemy and the Automatic Braking system. The vehicles sense the red light phase at every approaching intersection ahead of time by using the In-car traffic light system, thus to take an appropriate automatic action.

There is a threshold Safe Distance calculated by the system to slow down a vehicle before applying the Automatic Braking. After determining the In-car traffic light cycles and the GPS coordinates for the approaching intersections. The system detects the possibility of Running Red Lights when no signs of dropping the vehicle speed to certain levels within the first part of the Safe Distance (first phase), the system will take an immediate action by slowing the vehicle by decreasing the fuel rate depending on the slope of the traversed road or by applying the brakes automatically to slow the vehicle down. And when the vehicle reaches the Stopping Distance phase (the last phase of the Safe Distance), if the driver fails to respond or the system not sensing the ABS (anti-lock brakes) being initiated, Running Red Lights avoidance takes place, brakes will be applied automatically.

Note: When you step on the gas pedal, the throttle valve opens up more, letting in more air. The engine control unit (ECU, the computer that controls all of the electronic components on your engine) “sees” the throttle valve open and increases the fuel rate in anticipation of more air entering the engine. It is important to increase the fuel rate as soon as the throttle valve opens; otherwise, when the gas pedal is first pressed, there may be a hesitation as some air reaches the cylinders without enough fuel in it.

Sensors monitor the mass of air entering the engine, as well as the amount of oxygen in the exhaust. The ECU uses this information to fine-tune the fuel delivery so that the air-to-fuel ratio is just right.

Generally, for the Stopping Distance, at 65 mph the typical passenger car or light pickup truck driver will travel a total of 316 feet from the driver perceiving the danger before coming to a final stop. The semi-truck driver takes much longer traveling out 525 feet before coming to a final stop.

Tractor-trailers have larger brakes than passenger cars or light pickup trucks, however due to their weight it takes the big rig much longer to stop than a passenger car. Generally a big rig can weigh up to 80,000 pounds, while a passenger car may weigh about 5000 pounds. General Stopping Distance calculation at 40 mph indicates a passenger car or light pickup truck can come to a full stop in 140 feet from the driver perceiving the danger. The big truck at 40 mph however, travels 180 feet after the driver first perceives the danger before final stop.

It is common knowledge that a big rig takes much longer to stop than a passenger car or pick up truck. Calculating the Stopping Distance for any vehicle involves several different factors.

Factors affecting braking distance for passenger cars and pickup trucks are the condition of the roadway and also the weather conditions. Rain, ice or snow can increase braking distance substantially. Additionally the condition of the roadway and its coefficient of friction can play a part in the calculation of the expected Stopping Distance of a commercial vehicle. Also, the tread on the tires of a large truck and how the brakes are applied as well as the specific condition of the brakes involved will impact Stopping Distance.

Tilt Sensors (Inclinometers angle measurement devices) measure an angular position with reference to gravity and are used in a wide variety of applications from laser levels to seismic monitoring to medical devices. Many Tilt Sensors have precision capable of measuring ranges of arc seconds to 180°.

The Tilt Sensors inside the vehicle will determine the slope of the traversed road. Inclinometers are used to describe the measurement of the steepness of a straight line (the vehicle axis parallel to the direction of movement). The higher the slope, the steeper the line. When a vehicle going down a ramp it accelerates even without increasing the fuel rate under its weight, thus the Tilt Sensors provide the system with data needed to calculate the Safe Distance down a ramp.

The speed of the vehicle, the steepness of the road, the size of the vehicle and the weather conditions will determine the Safe Distance and the Stopping Distance, for instance if the vehicle speed is 40 mph for a passenger car on a dry road, the Safe Distance could start at 100 meter away from the approaching intersection, and the last 50 meter of the Safe Distance will be the Stopping Distance to fully stop the vehicle a number of meters just before reaching the intersection. For the same example if it is icy road, the Safe Distance could start at 200 meter away from the intersection and the Stopping Distance could start at 80 meter away from the intersection.

Note: The vehicle GPS coordinates can determine the geographic area historical weather data from the programmed database. Also the inputs from the ABS (anti-lock brakes) can indicate how much slippery is the road surface.

When the vehicle reaches a speed close to zero (or speed equal zero), or under 10 mph after applying the brakes or the Automatic Braking, the system allows the driver to accelerate the vehicle to make right or left turns when it is allowed, or moving forward when been directed in some situations such as construction sites or accident sites.

### The Virtual Preemption System for Emergency Vehicles:

To provide a priority safe route for the emergency vehicle, the present virtual preemption system neither rely on vehicle to street intersection communication nor network communication. The emergency vehicle communicates directly with the vehicles via the long range signal of Elsheemy.

As described above, the database tables shown in FIG. 13 are designed to initiate the intersection search to determine the intersection ID of two intersections the vehicle is moving between based on the vehicle latitude/longitude, after that the database can generate the upcoming intersections ID based on the direction of the vehicle movement. Therefore, the vehicle will know the latitude/longitude of the upcoming intersections ahead of time.

The GPS receiver module of the emergency vehicle unit can determine the speed of the vehicle and by knowing the distance between the emergency vehicle and an upcoming intersection, this distance along with the vehicle average speed can determine the estimated time it takes to reach that intersection. For instance if the current time is 10:37:14 pm when the distance between the vehicle and the intersection=800 meters, and the emergency vehicle speed is 45 mph=20.117 m/sec, thus the estimated time of arrival will be after 800/20.117=39.8 sec at 10:37:14+39.8 sec=10:37:53.8 pm. But we want to make sure that before that time the programmed traffic light cycles at that intersection (for all vehicles approaching that intersection) have enough time to make a transition from a green light phase to red light phase for directions conflict with the direction of the emergency vehicle. Therefore the emergency vehicle will start transmitting the data as soon as the distance reaches 800 meters or less from that intersection.

### Start Threshold Time

After that there will be a Start Threshold time for all the vehicles approaching that intersection to start flipping to the emergency light cycle at the same exact time. The Start Threshold time=the estimated time of arrival−10 seconds. For example, Start Threshold time=10:37:53.8 sec−10 sec=10:37:43.8 pm, at this exact time all of the vehicles approaching that intersection will flip to emergency light cycle phase after receiving a signal from the emergency vehicle.

Another example: for speed 60 mph=26.82 m/s at 800 meters away from an intersection, estimated time of arrival period=800/26.82=29.8 seconds and the Start Threshold time=10:37:14+29.8 sec−10 sec=10:37:33.8 pm, at this exact time all the vehicles at that intersection will flip to emergency cycle phase.

The 10 seconds in the above example could be reduced to 4 seconds if the emergency vehicle is too close to the intersection in some cases.

The transmitted signal will contain information about the emergency vehicle type (fire trucks F or ambulances A or police vehicles P or ordinary vehicle V) and the emergency vehicle ID (to identify the individual vehicle that requested the preemption access). The transmitted signal also contain the upcoming intersection ID and the Start Threshold time. When the vehicles receive the transmitted information, they will check whether the transmitted intersection ID is one of their upcoming intersections or not and if yes, it will use the transmitted Start Threshold time as a starting point to flip to the emergency light cycle, the emergency light cycle contains 6 or 4 seconds yellow light interval for directions conflict with the emergency vehicle direction before they turn into red light phase. All directions (exclude the direction of the emergency vehicle) at an upcoming intersection could be considered conflicting with the emergency vehicle direction in some embodiments.

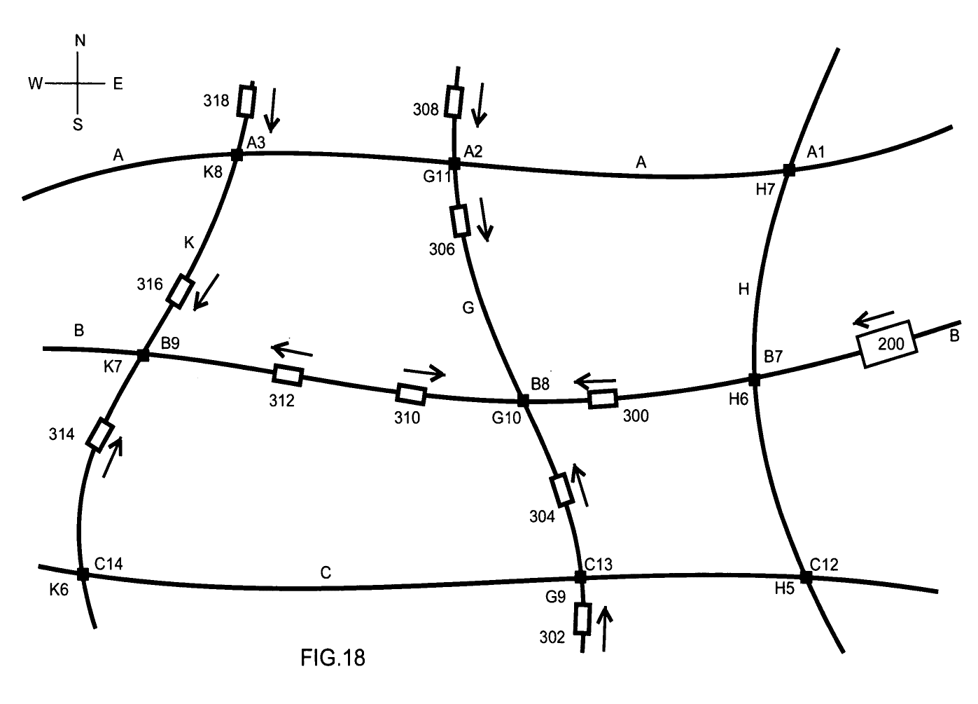

FIG. 18 illustrates an example of the present invention virtual preemption process, the emergency vehicle 200 is a fire truck F9732 moving westbound on street B, as described before in the SQL database tables of the geographic sections and the intersections ID as shown in FIG. 12, FIG. 13 and FIG. 14, the vehicle latitude/longitude can locate the vehicle between two intersections on the same road as shown in FIG. 13, and since the intersections ID number ascending westbound on horizontal streets, therefore the database can calculates the upcoming intersections the vehicle is headed toward. thus the emergency vehicle 200 is heading toward intersection B7 then B8 then B9.

Vertical street H intersects with horizontal street B at intersection B7, but latitude/longitude of intersection B7 is the same latitude/longitude of intersection H6 (H6 represent the street H). Thus, the database automatically determines intersection H6 by knowing intersection B7. Also, intersection G10 and intersection K7 are determined by the database same way as intersection H6. The vehicles 306 and 308 moving southbound on street G, therefore they are heading toward intersection G10, vehicles 302 and 304 moving northbound on street G and are heading toward intersection G10. vehicle 300 moving westbound on street B and heading toward intersection B8, vehicle 310 moving eastbound on street B and heading toward intersection B8. The emergency vehicle unit calculates the distance between the vehicle and the approaching intersections B7, B8 and B9 consecutively and when the distance reaches (800 meters or less), it calculates the expected arrival time period based on its speed then calculates a threshold time for each intersection. It will transmit (F9732,B7,3:27:15,START) then transmits (F9732,B8,3:27:46,START) then also transmit (F9732,B9,3:28:33,START) for example over the long range signal. All vehicles receive this signal will check their upcoming intersections whether include intersections B7, B8, B9, H6, G10 and K7 or not. For instance, vehicles 300, 310, 302, 304, 306 and 308 will see intersection B8/G10. Therefore their fixed traffic light cycle at intersection B8/G10 will be flipped to the emergency traffic light cycle automatically at 3:27:46.

If the status of the fixed time light cycle at intersection G10 has a green or yellow light phase at the Threshold time 3:27:46 for vehicles 302,304, 306 and 308 which have direction of moving conflict with the direction of the emergency vehicle 200, their emergency light cycle will start with 6 or few seconds of yellow light phase before it start the red light phase. Whereas, for vehicles 300 and 310 which have direction do not conflict with the direction of the emergency vehicle 200, and if their status of the fixed light cycle is red light phase at the Threshold time 3:27:46, their emergency light cycle will start with 7 seconds of red light phase before it start the green light phase. Furthermore if the status of the fixed time light cycle at intersection G10 has a red light phase at the Threshold time 3:27:46 for vehicles 302,304, 306 and 308, their emergency light cycle will start with red light phase. Whereas for vehicles 300 and 310 if their status of the fixed light cycle is yellow or green light phase at the Threshold time 3:27:46, their emergency light cycle will start with green light phase. After the emergency vehicle 200 crosses intersection B8 it will transmit an End Threshold time 3:28:01 for intersection B8/G10, for example it will transmit (F9732,B8,3:28:01,END). Vehicles 302,304,306,308,300 and 310 will end their emergency light cycle at 3:28:01. For vehicles 300 and 310 will start with 6 seconds of yellow light phase if their fixed light cycle for intersection B8 at the time 3:28:01 has a red light phase before flipping back to the fixed light cycle. For vehicles 302.304.306 and 308 will start with 7 seconds of red light phase if their fixed light cycle for intersection G10 at the time 3:28:01 has a green or yellow light phase before flipping back to the fixed light cycle.

Additionally, in one embodiment, since the emergency vehicle moves between two intersections and its direction can determine the next intersection ID based on ascending or descending numbering, then the intersection ID where the vehicle wants to make left/right turn must be the only intersection to flip to the turning mode while other intersections on the same street before turning must end the emergency light cycle mode. Therefore if the emergency vehicle 200 will make left/right turn at intersection B8, the vehicle must be between intersection B7 and intersection B8 before the emergency vehicle driver presses on the left/right button (signal). Thus the database will determine intersection B8 as the affected intersection and the emergency vehicle 200 transmits (F9732,B8,3:27:30,TURN) for intersection B8 and also transmits (F9732,B9,3:27:30,END) for intersection B9 for example. At 3:27:30 intersection B8/G10 will start with 6 seconds of yellow light phase for any direction has yellow or green light phase before turning into red light phase, thus all vehicles 300,310,304 and 306 will have red light phase. The time 3:27:30 is when the driver pressed on the left/right turn signal/button.

During the emergency light cycle, vehicles 300 and 310 will have their green LED indicator 61 blinking to indicate they are in the same street of the emergency vehicle 200 (or a message on their LCD screen to indicate that). Whereas vehicles 302,304 and 306 will have their red LED 63 indicator blinking to indicate they are intersect with the emergency vehicle street (or a message on their LCD screen to indicate that). For the emergency vehicle 200 will have its green LED 61 indicator blinking or solid green (or a message on their LCD screen to indicate that).

More than One Emergency Vehicle:

If there are more than one emergency vehicle want to cross an intersection, the fire trucks have the priority over ambulances, and ambulances have a priority over police vehicles and police vehicles have a priority over an ordinary vehicle which may obtain a priority code from the 911 emergency services.

For example if vehicles received F9732,B8,3:27:46,START from a fire truck and also received P3467,G10,3:27:43,START from a police car, the vehicles (including the emergency vehicles) are programmed to check the difference of the Start Threshold time: 3:27:46−3:27:43=3 seconds < Safe time period (10 seconds for example). Thus the vehicles will apply F9732,B8,3:27:46,START even the fire truck came 3 seconds after the police vehicle. The police vehicle may also display the path of the fire truck on the GPS map on its LCD unit.

Whereas if the vehicles received F9732,B8,3:27:46,START and also received P3467,G10,3:27:30,START, the difference of the Start Threshold time 3:27:46−3:27:30=16 seconds > Safe time period (10 seconds). Thus the vehicles will apply P3467,G10,3:27:30,START based on first come first served manner. The fire truck will display the path of the police vehicle on the GPS map on its LCD unit.

After the police vehicle crosses the intersection, the vehicles will apply the F9732,B8,3:27:46,START.

### Signal Repeaters

The civilians vehicles will act as signal repeaters to repeat sending the emergency vehicle preemption signals to make sure all vehicles received the preemption signal in case of the emergency vehicle original signal is blocked by terrains or buildings within the signal range.

### Civilians Vehicles and Priority Route:

For the ordinary vehicles there are some occasions wherein civilians in urgent situation may require to obtain a priority route to reach a hospital such as a spouse or a child or an elderly person or a coworker needs an immediate medical attention while the emergency vehicles not available or may take long time to arrive for example. In this case the vehicle unit V10 programmed to generate a priority code derived from the vehicle VIN code also the real date and time.

The 9-1-1 emergency services will have a database of vehicles registered in the priority system, the driveres will register their vehicles in the priority system as an smartphone app or other forms of registration. Whenever an urgent emergency require obtaining a priority route, the driver calls 911 emergency service to explain his urgent situation and if he or she has a legitimate cause, the 911 operator will grant him a 4 digit code derived from his vehicle VIN code also the real date and time to match the same code generated by his vehicle unit V10. To benefit from the priority access for a short limited period of time to reach his destination.

The driver may input this code via the LCD 40 voice recognition system or via bluetooth of the vehicle unit V10 paired with his smartphone or via the touch screen LCD unit.

The preemption process for civilian vehicles will be exactly similar to the emergency vehicles. Additionally, the civilians vehicles may be equipped with miniature sirens or miniature flashing colored lights that mimic the ones in the actual emergency vehicles.

### Funeral Motorcade

A funeral cortege is a procession of mourners, most often in a motorcade of vehicles following a hearse. This is another example of using the virtual preemption system for non emergency vehicles. The leading vehicle can obtain the priority 4 digits code to give access to the rest of the motorcade since they move in the same direction, but in this case the End Threshold time must provide enough time for the last vehicle in the motorcade to proceed before other cars flip back to their programmed fixed light cycles.

While the present in-car-traffic light and the virtual preemption systems cover the vast majority of traffic light intersections of urban and rural geographic areas, in some rare situations in streets surrounded by skyscrapers or tall buildings wherein no GPS signal, it may be appropriate to apply the conventional intersection infrastructure for a number of intersections and the traffic controller or the intersection unit as of Elsheemy (the unit in charge of receiving the preemption request data from the emergency vehicle) of these intersections will be programmed to recognize its respective intersection ID and use the same exact method of vehicles described in the present virtual preemption system as illustrated in FIG. 18. In this case the vehicles at the intersections will rely on the actual intersection traffic light signals. Also the actual intersection's non-emergency traffic light signals will be the same fixed light cycles programmed in the database of the vehicles as explained previously in SQL tables. Therefore, the intersection unit may receive a signal from the emergency vehicle as (F9732,M19,3:28:33,START) for example, wherein M19 is the intersection ID of an actual intersection equipped with conventional traffic light signals and the intersection unit of Elsheemy.

Certain additional advantages and features of this invention may be apparent to those skilled in the art upon studying the disclosure, or may be experienced by persons employing the novel system and method of the present invention. Other advantages of the present invention include enhancing traffic safety, reduce cost, reduce accidents rates, death rates, injuries rates and damage rates at intersections.

While the invention has been described with a limited number of embodiments, it will be appreciated that changes may be made without departing from the scope of the original claimed invention, and it is intended that all matter contained in the foregoing specification and drawings be taken as illustrative and not in an exclusive sense.

1. A system for in-car traffic light integrating with the vehicle automatic brake system for running red lights avoidance; The system for in-car traffic light integrating with the emergency vehicle virtual preemption system; comprising, a GPS receiver module as a component of the vehicle unit to determine coordinates, speed, direction and date and time at real-time status; GPS database of virtual trails of track points to determine the leg segments of intersections, a fixed time traffic light cycle database in which the fixed time light cycle mimics the average time of the actuated traffic light cycle for each leg segment for each direction at intersections; wherein the leg segment could be a section of a road between two consecutive intersections or it could be a section of a road with only one end at an intersection; also comprising; LCD unit, LED strip unit, heads-up display unit.

2. The system for in-car traffic light of claim 1 wherein the leg segments in the database are defined as a horizontal segment with an east end and a west end, a vertical segment with a north end and a south end, and an one way segment with only one approaching end in east/west or north/south direction.

3. The system for in-car traffic light of claim 1 wherein the vehicle unit determines the leg segment by comparing its position coordinates to the coordinates of the database and to confirm it by comparing the coordinates of a next position apart from the 1st position with the coordinates of the database.

4. The system for in-car traffic light of claim 1 wherein the coordinates reading of two consecutive positions of the vehicle unit can determine the direction of moving.

5. The system for in-car traffic light of claim 1 wherein an intersection leg could be assigned one or more light cycle, one for the high traffic period, a further one for medium traffic period and a further one for the low traffic period of the day in each end of the leg segment.

6. The system for in-car traffic light of claim 1 wherein determining the leg segment from the GPS database and the direction of moving will determine the intersection ID; wherein the intersection ID and the moving direction will determine the light cycles ID and the coordinates of the intersection; wherein the traffic light cycle database comprises the light cycles ID and the time phases of the light; wherein LED indicators of the LCD will illuminate after determining the programmed light phases; wherein the LED indicators will go blank for 2 seconds before the start of a new light cycle; wherein the green LED indicator will be blinking if a red light phase in the next light cycle for an upcoming intersection in close proximity.

7. The time phases for each light cycle ID from the traffic light cycle database of claim 6 comprise; delay time phase in seconds, turn time phase in seconds, green time phase in seconds, yellow time phase in seconds and red time phase in seconds; wherein delay time phase is the delay time of the first light cycle from a period's starting time (periods of claim 5); wherein the light cycle repeats itself until the start of a next period; wherein the repeated cycle only include (turn time phase, green time phase, yellow time phase and red time phase); wherein a red light cycle only include red time phase and a yellow light cycle only include yellow time phase.

8. The system for in-car traffic light of claim 1 wherein the owners of the vehicles can obtain the GPS database of the track points, the traffic light cycles database and maps in CD-ROM format and load them onto the vehicle unit or use microSD memory cards that are preloaded with database of track points and the traffic light cycles database.

9. The vehicle unit's LCD comprising; a number of LED indicators to be used for the in-car traffic light system, wherein a green LED indicator for proceeding at an intersection, a yellow LED indicator to prepare to stop short of the intersection, a red LED indicator for a complete stop at an intersection, a green right-turning arrow LED indicator for right turning, a green left-turning arrow LED indicator for left turning and an intersection indicator; wherein a LED indicator only illuminates when the vehicle is less than few meters away from a programmed intersection during yellow or red light phases.

10. The LED strip unit and the heads-up display unit of claim 1 comprise the same LED indicators and the intersection indicator of the LCD unit; wherein the LED strip unit can be in a horizontal or vertical orientation; wherein the intensity of the yellow or the red LED indicators increases when the vehicle is less than few meters away from a programmed intersection during yellow or red light phases; wherein audio alert can be used to indicate when the vehicle is less than few meters away from a programmed intersection during yellow or red light phases.

11. The traffic light phases of claim 9 can be displayed on a colored screen of the vehicle unit's LCD; wherein the screen partially or fully indicates the yellow or red light phases when the vehicle is less than few meters away from a programmed intersection during yellow or red light phases.

12. Sun visors of vehicles made of transparent materials similar to Sunglasses to allow the drivers to have line-of-sight with the LCD or the heads-up-display of claim 1.

13. A system for emergency vehicle virtual preemption to provide a priority safe route for emergency vehicles, the system neither rely on vehicle to intersection communication nor network communication.

14. The system for emergency vehicle virtual preemption of claim 13 is integrating with the in-car traffic light system of claim 1 and comprising; a long range transceiver as a component of the emergency vehicle unit to transmit preemption codes to all vehicles approaching intersections on the priority route of the emergency vehicle.

15. The intersections on the priority route of the emergency vehicle of claim 14 are determined by matching the emergency vehicle latitude/longitude to the GPS database as of claims 2, 3, 4 and 6.

16. The intersection coordinates of claim 6 along with the emergency vehicle speed are used to calculate a threshold time for vehicles approaching a specific intersection on the priority route of the emergency vehicle to start flipping their in-car traffic light cycles to the emergency light cycle at the same exact time.

17. The preemption codes of claim 14 include; the emergency vehicle type and ID, intersection ID, threshold time to start/end the emergency light cycle; threshold time for left/right turning.

18. The emergency vehicle type of claim 17 includes, fire trucks have a priority over ambulances, and ambulances have a priority over police vehicles and police vehicles have a priority over an ordinary vehicle; wherein the vehicles compare the threshold start time and the emergency vehicle type to select which emergency vehicle to apply its preemption codes.

19. The ordinary vehicles of claim 18 wherein civilians in urgent situation can obtain a priority route to reach a hospital or the like; wherein the vehicle unit of claim 1 programmed to generate a priority code derived from the vehicle VIN code along with the real date and time; wherein the priority code will match the code generated by the 9-1-1 emergency services; wherein the drivers register their vehicles in the priority system of the 9-1-1 emergency services to request a priority route; wherein a driver calls 9-1-1 emergency service to explain his urgent situation to verify if he has a legitimate cause and obtain a priority code to input it into his vehicle unit.

20. The virtual preemption process for the ordinary vehicles of claim 19 includes the same process of claims 13-18.

21. A system for running red lights avoidance of claim 1 wherein the in-car traffic light system of claims 1-10 integrating with the vehicle automatic brake system to detect the possibility of Running Red Lights when no signs of dropping the vehicle speed to certain levels within a first phase of a Safe Distance, the system takes an immediate action by slowing the vehicle; wherein, brakes will be applied automatically during the red light phase of the in-car traffic light cycle at an intersection when the vehicle enters the Stopping Distance phase if the driver fails to respond or the system not sensing the anti-lock brakes being initiated.

22. The Safe Distance's first phase of claim 21 is the first part of threshold Safe Distance calculated by the system to slow down a vehicle before applying the Automatic Braking; wherein determining the in-car traffic light cycles and the GPS coordinates for the approaching intersections as of claim 6 is used to calculate a threshold Safe Distance between the vehicle and a programmed intersection.

23. The Stopping Distance phase of claim 21 is the second part of the threshold Safe Distance of claim 22 wherein, brakes will be applied automatically if the driver fails to respond to stop his vehicle or the system not sensing the anti-lock brakes being initiated.

24. The Safe Distance and the Stopping Distance of claim 21 calculated based on the size and the speed of the vehicle, the steepness of the road, the condition of the roadway and the weather conditions.

25. The vehicle GPS coordinates used to determine the weather conditions from weather database.

26. The system for running red lights avoidance of claim 21 allows the driver to accelerate his vehicle to make right/left turn or moving forward if the vehicle speed equal zero after applying the brakes or the Automatic Braking.
